(19) United States
(12) Patent Application Publication
(10) Pub. No.: US 2016/0357073 A1
(43) Pub. Date: Dec. 8, 2016

(54) PIXEL STRUCTURE, ARRAY SUBSTRATE AND DISPLAY DEVICE

(71) Applicants: BOE TECHNOLOGY GROUP CO., LTD., Beijing (CN); HEFEI XINSHENG OPTOELECTRONICS TECHNOLOGY CO., LTD., Anhui (CN)

(72) Inventors: Xinxia ZHANG, Beijing (CN); Fengzhen LV, Beijing (CN); Xiao GUO, Beijing (CN); Kang XIANG, Beijing (CN); Chen WANG, Beijing (CN); Kui LV, Beijing (CN)

(73) Assignees: BOE TECHNOLOGY GROUP CO., LTD., Beijing (CN); HEFEI XINSHENG OPTOELECTRONICS TECHNOLOGY CO., LTD., Anhui (CN)

(21) Appl. No.: 15/096,895

(22) Filed: Apr. 12, 2016

(30) Foreign Application Priority Data
Jun. 3, 2015 (CN) 201510299341.8

(51) Int. Cl. G02F 1/1343; G02F 1/1368; G02F 1/1362

(52) U.S. Cl. CPC G02F 1/134309; G02F 1/136286; G02F 1/1368; G02F 1/13624; G02F 2001/134345

(57) ABSTRACT

A pixel structure according to embodiments of the present disclosure may include a plurality of sub-pixel units driven by a same gate line and a same data line. Each of the sub-pixel units may consist of two or more sub-pixels, and be divided into N display regions. In a power-on state, an N-domain display may be implemented by the sub-pixel unit due to different electric fields generated by different display regions respectively. Technical solutions of the present disclosure can improve chromatic aberration phenomenon of a LCD device with transmittance of the LCD device being guaranteed.

### CROSS-REFERENCE TO RELATED APPLICATION

The present application claims a priority of the Chinese patent application No. 201510299341.8 filed on Jun. 3, 2015, which is incorporated herein by reference in its entirety.

### FIELD OF THE INVENTION

The present disclosure relates to the field of display technology, in particular to a pixel structure, an array substrate and a display device.

### DESCRIPTION OF THE PRIOR ART

An AD-SDS (ADvanced Super Dimension Switch, ADS for short) mode LCD (Liquid Crystal Display) is being gradually used widely due to its advantages such as wide viewing angle, high transmittance, low chromatic aberration. In particular, the ADS technology may mainly be described as forming a multi-dimensional electric field by means of electric fields generated at edges of slit electrodes within an identical plane and an electric field generated between a slit electrode layer and a plate electrode layer, so as to enable all the liquid crystal molecules between the slit electrodes and right above the electrodes within a liquid crystal cell to rotate, thereby to improve the operational efficiency of the liquid crystal molecules and enhance the light transmission efficiency. The ADS technology may be used to improve the image quality of a TFT-LCD product, and has such advantages as high resolution, high transmittance, low power consumption, wide viewing angle, high aperture ratio, low chromatic aberration and free of push Mura.

A sub-pixel unit of an array substrate of the ADS mode LCD contains two layers of transparent electrodes, i.e., a first transparent electrode and a second transparent electrode right over the first transparent electrode. One of the first transparent electrode and the second transparent electrode, which is used as a pixel electrode, is connected to a drain electrode of a TFT (thin film transistor), and the other of the first transparent electrode and the second transparent electrode, which is used as a common electrode, is connected to a common electrode line. The pixel electrode is generally a pixel electrode strip (also referred to as a slit electrode) with a certain width and space. The pixel electrode and the common electrode are vertically stacked, and are separated by an insulation layer.

In design of an array substrate of an early ADS mode LCD, the pixel electrode strip only has one inclination angle. As shown in FIG. 1, the array substrate includes: a gate line 1, data lines 2, strip pixel electrodes 3, apertures 4 between the strip pixel electrodes 3, a source electrode 5 and a drain electrode 6. When such a LCD works, there is only one deflection angle for liquid crystal 7 in each of sub-pixels in a case that the liquid crystal is driven by an electric field, as shown in FIG. 2. With different observation viewing angles, the LCD has difference in brightness due to anisotropy of the liquid crystal, and thus has a certain chromatic aberration.

### SUMMARY OF THE INVENTION

A technical problem to be solved by the present disclosure is to provide a pixel structure, an array substrate and a display device, which can improve chromatic aberration phenomenon of an LCD device with transmittance of the LCD device being guaranteed.

In order to solve the technical problem as described above, embodiments of the present disclosure propose technical solutions as follows.

According to a first aspect of the present disclosure, a pixel structure, comprising a plurality of sub-pixel units driven by a same gate line and a same data line, is provided. Each of the sub-pixel units consists of two or more sub-pixels, and is divided into N display regions; and in a power-on state, an N-domain display is implemented by the sub-pixel unit due to different electric fields generated by different display regions respectively.

Further, each of the sub-pixel units may be divided into four display regions.

Further, each of the sub-pixel units may include two sub-pixels driven by the same gate line and the same data line, each sub-pixel being divided into two display regions.

Further, each of the sub-pixel units may consist of a first sub-pixel and a second sub-pixel distributed in a substantially parallel direction along the gate line, the sub-pixel unit comprising a first thin film transistor (TFT) which drives the first sub-pixel for display and a second TFT which drives the second sub-pixel for display, a gate electrode of the first TFT being connected to a gate electrode of the second TFT, a source electrode of the first TFT being connected to a source electrode of the second TFT; in a substantially parallel direction along the data line, the first sub-pixel is divided into a first region and a second region whose areas are substantially identical, and the second sub-pixel is divided into a third region and a fourth region whose areas are substantially identical; and strip pixel electrodes of the first region and the second region are arranged symmetrically, and strip pixel electrodes of the third region and the fourth region are arranged symmetrically;

wherein

inclination angles of the strip pixel electrodes of the first region and the third region are substantially identical, width-length ratios of channels of the first TFT and the second TFT are substantially identical, and areas of the first region and the third region are different; or

inclination angles of the strip pixel electrodes of the first region and the third region are substantially identical, width-length ratios of channels of the first TFT and the second TFT are different, and areas of the first region and the third region are substantially identical; or

inclination angles of the strip pixel electrodes of the first region and the third region are different, width-length ratios of channels of the first TFT and the second TFT are substantially identical, and areas of the first region and the third region are substantially identical.

Further, each of the sub-pixel units may consist of a first sub-pixel and a second sub-pixel distributed in a substantially parallel direction along the data line, the sub-pixel unit comprising a first TFT which drives the first sub-pixel for display and a second TFT which drives the second sub-pixel for display, a gate electrode of the first TFT being connected to a gate electrode of the second TFT, a source electrode of the first TFT being connected to a source electrode of the second TFT; in a substantially parallel direction along the gate line, the first sub-pixel is divided into a first region and a second region whose areas are substantially identical, and the second sub-pixel is divided into a third region and a fourth region whose areas are substantially identical; and strip pixel electrodes of the first region and the second region are arranged symmetrically, and strip pixel electrodes of the third region and the fourth region are arranged symmetrically;

wherein

inclination angles of the strip pixel electrodes of the first region and the third region are substantially identical, width-length ratios of channels of the first TFT and the second TFT are substantially identical, and areas of the first region and the third region are different; or

inclination angles of the strip pixel electrodes of the first region and the third region are substantially identical, width-length ratios of channels of the first TFT and the second TFT are different, and areas of the first region and the third region are substantially identical; or

inclination angles of the strip pixel electrodes of the first region and the third region are different, width-length ratios of channels of the first TFT and the second TFT are substantially identical, and areas of the first region and the third region are substantially identical.

Further, each of the sub-pixel units may include four sub-pixels driven by the same gate line and the same data line, each sub-pixel being as one display region.

Further, each of the sub-pixel units may include a first sub-pixel and a second sub-pixel whose areas are substantially identical as well as a third sub-pixel and a fourth sub-pixel whose areas are substantially identical, and further include a first TFT which drives the first sub-pixel for display, a second TFT which drives the second sub-pixel for display, a third TFT which drives the third sub-pixel for display, a fourth TFT which drives the fourth sub-pixel for display, gate electrodes of the first TFT, the second TFT, the third TFT and the fourth TFT being connected, source electrodes of the first TFT, the second TFT, the third TFT and the fourth TFT being connected; in a substantially parallel direction along the gate line, strip pixel electrodes of the first sub-pixel and the second sub-pixel are arranged symmetrically, strip pixel electrodes of the third sub-pixel and the fourth sub-pixel are arranged symmetrically, width-length ratios of channels of the first TFT and the second TFT are substantially identical, and width-length ratios of channels of the third TFT and the fourth TFT are substantially identical;

wherein

inclination angles of the strip pixel electrodes of the first sub-pixel and the third sub-pixel are substantially identical, width-length ratios of channels of the first TFT and the third TFT are substantially identical, and areas of the first sub-pixel and the third sub-pixel are different; or

inclination angles of the strip pixel electrodes of the first sub-pixel and the third sub-pixel are substantially identical, width-length ratios of channels of the first TFT and the third TFT are different, and areas of the first sub-pixel and the third sub-pixel are substantially identical; or

inclination angles of the strip pixel electrodes of the first sub-pixel and the third sub-pixel are different, width-length ratios of channels of the first TFT and the third TFT are substantially identical, and areas of the first sub-pixel and the third sub-pixel are substantially identical.

Further, each of the sub-pixel units may include a first sub-pixel and a second sub-pixel whose areas are substantially identical as well as a third sub-pixel and a fourth sub-pixel whose areas are substantially identical, and further include a first TFT which drives the first sub-pixel for display, a second TFT which drives the second sub-pixel for display, a third TFT which drives the third sub-pixel for display, a fourth TFT which drives the fourth sub-pixel for display, gate electrodes of the first TFT, the second TFT, the third TFT and the fourth TFT being connected, source electrodes of the first TFT, the second TFT, the third TFT and the fourth TFT being connected; in a substantially parallel direction along the data line, strip pixel electrodes of the first sub-pixel and the second sub-pixel are arranged symmetrically, strip pixel electrodes of the third sub-pixel and the fourth sub-pixel are arranged symmetrically, width-length ratios of channels of the first TFT and the second TFT are substantially identical, and width-length ratios of channels of the third TFT and the fourth TFT are substantially identical;

wherein

inclination angles of the strip pixel electrodes of the first sub-pixel and the third sub-pixel are substantially identical, width-length ratios of channels of the first TFT and the third TFT are substantially identical, and areas of the first sub-pixel and the third sub-pixel are different; or

inclination angles of the strip pixel electrodes of the first sub-pixel and the third sub-pixel are substantially identical, width-length ratios of channels of the first TFT and the third TFT are different, and areas of the first sub-pixel and the third sub-pixel are substantially identical; or

inclination angles of the strip pixel electrodes of the first sub-pixel and the third sub-pixel are different, width-length ratios of channels of the first TFT and the third TFT are substantially identical, and areas of the first sub-pixel and the third sub-pixel are substantially identical.

Further, in a liquid crystal display (LCD) panel in which a number of pixel structures are applied, when liquid crystal of the display region in which the strip pixel electrodes are located is positive liquid crystal, a range of an angle between an inclination orienting direction of the strip pixel electrodes and an initial orienting direction of the positive liquid crystal may be 5°˜20°; or when liquid crystal of the display region in which the strip pixel electrodes are located is negative liquid crystal, a range of an angle between an inclination orienting direction of the strip pixel electrodes and an initial orienting direction of the negative liquid crystal may be 70°˜85°.

Further, an area ratio between the first region and the third region may be within a range from 1:1 to 1:9, and an area ratio between the second region and the fourth region may be within a range from 1:1 to 1:9.

According to a second aspect of the present disclosure, an embodiment of the present disclosure further provides an array substrate, comprising the pixel structure as described above.

According to a third aspect of the present disclosure, an embodiment of the present disclosure further provides a display device, comprising the array substrate as described above.

The embodiments of the present disclosure have beneficial effects as follows.

In the above technical solutions, the sub-pixel unit driven by the same gate line and the same data line is divided into a plurality of display regions, and in the power-on state, the electric fields generated by respective display regions are different. As such, when an LCD device works, the deflection angles of the liquid crystal of the respective display regions are different, which can implement a multi-domain display, so that difference in brightness of the LCD device is further reduced, and thus the chromatic aberration phenomenon is effectively improved. In addition, since each sub-pixel unit includes two or more sub-pixels, it is not necessary to form strip pixel electrodes having a plurality of inclination angles in each sub-pixel, which can reduce adverse effect on the transmittance of the LCD device.

### BRIEF DESCRIPTION OF THE DRAWINGS

In order to clearly illustrate embodiments of the present disclosure or technical solutions in the prior art, the drawings used for description of the embodiments or the conventional solutions will be briefly introduced hereinafter. Obviously, the drawings only concern some of the embodiments of the present disclosure. The skilled in the art may obtain other drawings based on the drawings below without creative labor.

FIG. 1 is a schematic view showing a structure of an existing array substrate;

FIG. 2 is a schematic view showing an orientation of liquid crystal corresponding to the array substrate as shown in FIG. 1;

FIG. 3 is a schematic view showing a structure of a dual-domain display mode array substrate;

FIG. 4 is a schematic view showing an orientation of liquid crystal corresponding to the array substrate as shown in FIG. 3;

FIGS. 5-8 are schematic view showing pixel structures according to embodiments of the present disclosure; and

FIG. 9 is a schematic view showing an orientation of liquid crystal corresponding to the pixel structures according to an embodiment of the present disclosure.

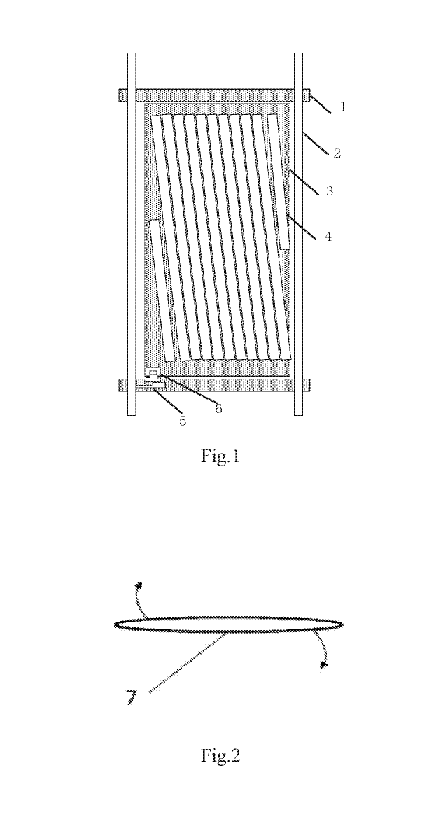

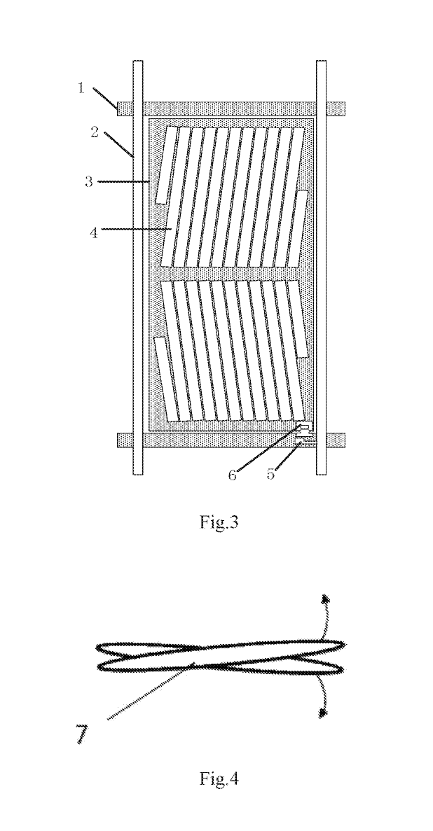

### REFERENCE NUMBERS

1—Gate Line 2—Data Line 3—Pixel Electrode Strip 4—Aperture Between Strip pixel electrodes 5—Source Electrode 6—Drain Electrode 7—Liquid Crystal

### DETAILED DESCRIPTION OF THE PREFERRED EMBODIMENTS

Hereinafter, particular implementations of the present disclosure will be described in detail in conjunction with the drawings and the embodiments. The embodiments below are only used for illustration, but not limitations on the scope of the present disclosure.

In order to make the objects, the technical solutions and the advantages of the present disclosure more apparent, the present disclosure will be described hereinafter in a clear and complete manner in conjunction with the drawings and embodiments. Obviously, the following embodiments are merely a part of, rather than all of, the embodiments of the present disclosure, and based on these embodiments, a person skilled in the art may obtain the other embodiments, which also fall within the scope of the present disclosure.

Unless otherwise defined, any technical or scientific terms used herein shall have the common meaning understood by a person of ordinary skills. Such words as “first” and “second” used in the specification and claims are merely used to differentiate different components rather than to represent any order, number or importance. Similarly, such words as “one” or “one of” are merely used to represent the existence of at least one member, rather than to limit the number thereof. Such words as “connect” or “connected to” may include electrical connection, direct or indirect, rather than being limited to physical or mechanical connection. Such words as “on/above”, “under/below”, “left” and “right” are merely used to represent relative position relationship, and when an absolute position of an object is changed, the relative position relationship will be changed too.

In order to make the technical problem, the technical solutions and the advantages of the embodiments of the present disclosure more apparent, the present disclosure will be described hereinafter in conjunction with the drawings and the embodiments.

Embodiments of the present disclosure provide a pixel structure, an array substrate and a display device, which can improve chromatic aberration phenomenon of an LCD device with transmittance of the LCD device being guaranteed.

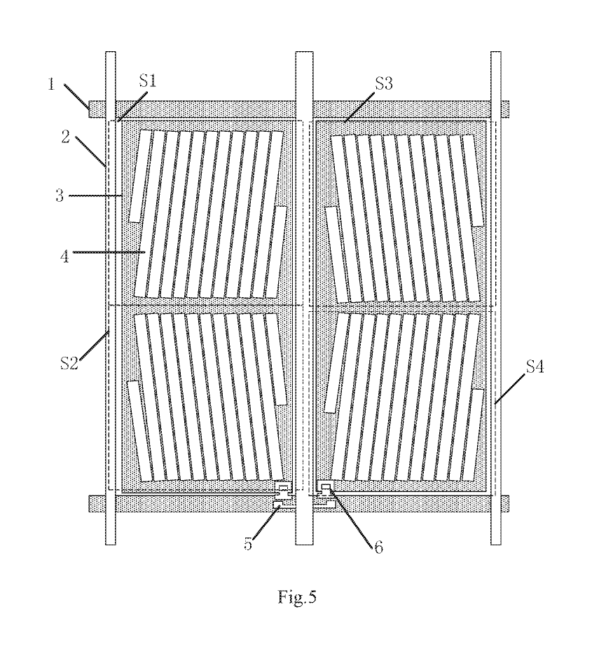

As shown in FIG. 3, the sub-pixels include a dual-domain display region (the display region of the sub-pixels is a region covered by the pixel electrodes excluding the TFT), i.e., the strip pixel electrodes 3 having two inclination angles. When such an LCD works, there are two deflection angles for liquid crystal 7 in each of the sub-pixels in a case that the liquid crystal is driven by the electric field, as shown in FIG. 4. With different observation viewing angles, the difference in brightness of the LCD is reduced due to an effect of averaging deflection of the liquid crystal 7. Thus, the chromatic aberration is improved to some extent. However, this technical solution can improve the chromatic aberration to some extent only, but the chromatic aberration phenomenon of the LCD still needs to be further improved. For example, there are four inclination angles for the strip pixel electrodes of one sub-pixel. When such an LCD works, there are four deflection angles for liquid crystal 7 in each of the sub-pixels in a case that the liquid crystal is driven by the electric field, which may greatly improve the chromatic aberration phenomenon of the LCD. Due to process limitations, however, the strip pixel electrodes which form four deflection angles in one sub-pixel will significantly affect the transmittance of the LCD.

### First Embodiment

The present embodiment provides a pixel structure, comprising a plurality of sub-pixel units driven by a same gate line and a same data line. Each of the sub-pixel units consists of two or more sub-pixels, and is divided into N display regions; and in a power-on state, an N-domain display is implemented by the sub-pixel unit due to different electric fields generated by different display regions respectively.

In the present embodiment, the sub-pixel unit driven by the same gate line and the same data line is divided into the plurality of display regions; and in the power-on state, the electric fields generated by respective display regions are different. As such, when the LCD device works, the deflection angles of the liquid crystal of the respective display regions are different, which can implement a multi-domain display, so that the difference in brightness of the LCD device is further reduced, and thus the chromatic aberration phenomenon is effectively improved. In addition, since each sub-pixel unit includes two or more sub-pixels, it is not necessary to form strip pixel electrodes having a plurality of inclination angles in each sub-pixel, which can reduce adverse effect on the transmittance of the LCD device.

The more the number of the display regions is, the more complex the manufacture process is. Thus, it is preferable that the number of the display regions is 2, 3 or 4. When the number of the display regions is 2, the LCD device can implement a dual-domain display. In addition, when the number of the display regions is 3, the LCD device can implement a three-domain display. In addition, when the number of the display regions is 4, the LCD device can implement a four-domain display.

Hereinafter, each sub-pixel unit being divided into four display regions for enabling the four-domain display will be taken as an example for illustrating the pixel structure of the present disclosure in detail.

First Situation—each of the sub-pixel units including two sub-pixels driven by the same gate line and the same data line, each sub-pixel being divided into two display regions.

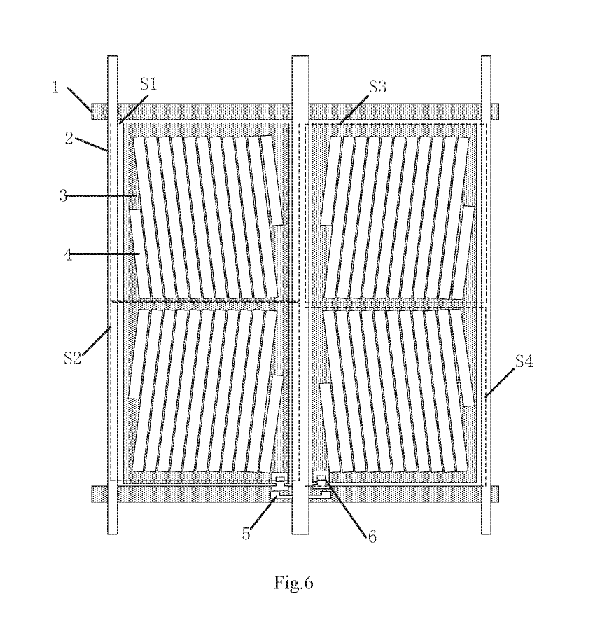

As shown in FIG. 5 and FIG. 6, in a particular example, each of the sub-pixel units consists of a first sub-pixel and a second sub-pixel distributed in a substantially parallel direction along the gate line 1, the first sub-pixel and the second sub-pixel being arranged at the same side of the gate line 1 which drives the sub-pixel units and being distributed at different sides of the data line which drives the sub-pixel units. The sub-pixel unit includes a first TFT which drives the first sub-pixel for display and a second TFT which drives the second sub-pixel for display. A gate electrode of the first TFT is connected to a gate electrode of the second TFT, and a source electrode of the first TFT is connected to a source electrode of the second TFT, so as to ensure that the first TFT and the second TFT are driven by the same gate line and the same data line. In a substantially parallel direction along the data line 2, the first sub-pixel is divided into a first region S1 and a second region S2 whose areas are substantially identical, and the second sub-pixel is divided into a third region S3 and a fourth region S4 whose areas are substantially identical. A set of strip pixel electrodes 3 with substantially the same inclination angle is arranged in each of the display regions as described above. The strip pixel electrodes 3 of the first region S1 and the second region S2 are arranged symmetrically, and the strip pixel electrodes 3 of the third region S3 and the fourth region S4 are arranged symmetrically.

In order that in the power-on state, the electric fields generated by the respective display regions are different, and thus the deflection angles of the liquid crystal of the respective display regions are individually different for implementing the four-domain display. In particular implementations may include, but be not limited to:

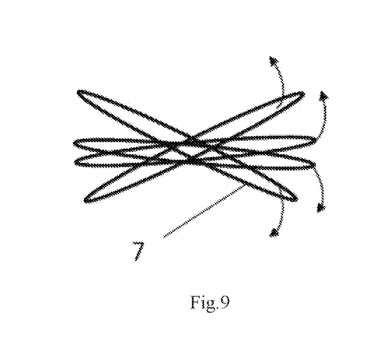

First Implementation 1, in which the inclination angles of the strip pixel electrodes of the first region S1 and the third region S3 are substantially identical, and the inclination angles of the strip pixel electrodes of the second region S2 and the fourth region S4 are substantially identical, either; width-length ratios of channels of the first TFT and the second TFT are substantially identical; and areas of the first region S1 and the third region S3 are different, and areas of the second region S2 and the fourth region S4 are different. As such, the deflection angles of the liquid crystal of the respective display regions are individually different in the power-on state. As shown in FIG. 9, there are four deflection angles of the liquid crystal 7 in the LCD device. Therefore, with observations in different viewing angles, anisotropy of the liquid crystal is well averaged, which can further reduce the chromatic aberration of the LCD device. In order to reduce the chromatic aberration better to obtain a better display effect, an area ratio between the first region S1 and the third region S3 may be within a range from 1:1 to 1:9, and accordingly, an area ratio between the second region S2 and the fourth region S4 may be within a range from 1:1 to 1:9.

Second Implementation 2, in which the inclination angles of the strip pixel electrodes of the first region S and the third region S3 are substantially identical, and the inclination angles of the strip pixel electrodes of the second region S2 and the fourth region S4 are substantially identical, either; the width-length ratios of channels of the first TFT and the second TFT are different; and the areas of the first region S1 and the third region S3 are substantially identical, and the areas of the second region S2 and the fourth region S4 are substantially identical. As such, the deflection angles of the liquid crystal of the respective display regions are individually different in the power-on state. As shown in FIG. 9, there are four deflection angles of the liquid crystal 7 in the LCD device. Therefore, with observations in different viewing angles, anisotropy of the liquid crystal is well averaged, which can further reduce the chromatic aberration of the LCD device.

Third Implementation 3, in which the inclination angles of the strip pixel electrodes of the first region S1 and the third region S3 are different, and the inclination angles of the strip pixel electrodes of the second region S2 and the fourth region S4 are different, either; the width-length ratios of channels of the first TFT and the second TFT are substantially identical; and the areas of the first region S and the third region S3 are substantially identical, and the areas of the second region S2 and the fourth region S4 are substantially identical. As such, the deflection angles of the liquid crystal of the respective display regions are individually different in the power-on state. As shown in FIG. 9, there are four deflection angles of the liquid crystal 7 in the LCD device. Therefore, with observations in different viewing angles, anisotropy of the liquid crystal is well averaged, which can further reduce the chromatic aberration of the LCD device.

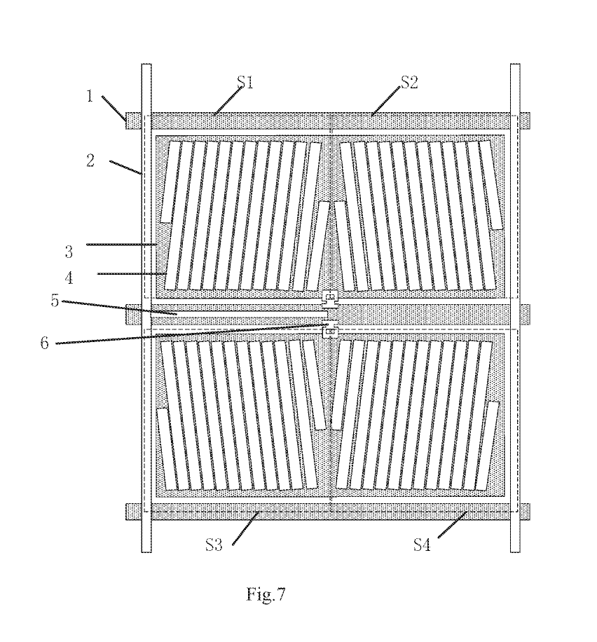

As shown in FIG. 7, in another particular example, each of the sub-pixel units consists of a first sub-pixel and a second sub-pixel distributed in a substantially parallel direction along the data line 2, the first sub-pixel and the second sub-pixel being arranged at the same side of the data line which drives the sub-pixel units and being distributed at different sides of the gate line which drives the sub-pixel units. The sub-pixel unit comprises a first TFT which drives the first sub-pixel for display and a second TFT which drives the second sub-pixel for display. A gate electrode of the first TFT is connected to a gate electrode of the second TFT, and a source electrode of the first TFT is connected to a source electrode of the second TFT, so as to ensure that the first TFT and the second TFT are driven by the same gate line and the same data line. In a substantially parallel direction along the gate line, the first sub-pixel is divided into a first region S1 and a second region S2 whose areas are substantially identical, and the second sub-pixel is divided into a third region S3 and a fourth region S4 whose areas are substantially identical. A set of strip pixel electrodes 3 with substantially the same inclination angle is arranged in each of the display regions as described above. The strip pixel electrodes 3 of the first region S1 and the second region S2 are arranged symmetrically, and the strip pixel electrodes 3 of the third region S3 and the fourth region S4 are arranged symmetrically.

In order that in the power-on state, the electric fields generated by the respective display regions are different, and thus the deflection angles of the liquid crystal of the respective display regions are individually different for implementing the four-domain display. In particular implementations may include, but be not limited to:

First Implementation 1, in which the inclination angles of the strip pixel electrodes of the first region S1 and the third region S3 are substantially identical, and the inclination angles of the strip pixel electrodes of the second region S2 and the fourth region S4 are substantially identical, either; width-length ratios of channels of the first TFT and the second TFT are substantially identical; and areas of the first region S1 and the third region S3 are different, and areas of the second region S2 and the fourth region S4 are different. As such, the deflection angles of the liquid crystal of the respective display regions are individually different in the power-on state. As shown in FIG. 9, there are four deflection angles of the liquid crystal 7 in the LCD device. Therefore, with observations in different viewing angles, anisotropy of the liquid crystal is well averaged, which can further reduce the chromatic aberration of the LCD device. In order to reduce the chromatic aberration better to obtain a better display effect, an area ratio between the first region S1 and the third region S3 may be within a range from 1:1 to 1:9, and accordingly, an area ratio between the second region S2 and the fourth region S4 may be within a range from 1:1 to 1:9.

Second Implementation 2, in which the inclination angles of the strip pixel electrodes of the first region S1 and the third region S3 are substantially identical, and the inclination angles of the strip pixel electrodes of the second region S2 and the fourth region S4 are substantially identical, either; the width-length ratios of channels of the first TFT and the second TFT are different; and the areas of the first region S1 and the third region S3 are substantially identical, and the areas of the second region S2 and the fourth region S4 are substantially identical. As such, the deflection angles of the liquid crystal of the respective display regions are individually different in the power-on state. As shown in FIG. 9, there are four deflection angles of the liquid crystal 7 in the LCD device. Therefore, with observations in different viewing angles, anisotropy of the liquid crystal is well averaged, which can further reduce the chromatic aberration of the LCD device.

Third Implementation 3, in which the inclination angles of the strip pixel electrodes of the first region S1 and the third region S3 are different, and the inclination angles of the strip pixel electrodes of the second region S2 and the fourth region S4 are different, either; the width-length ratios of channels of the first TFT and the second TFT are substantially identical; and the areas of the first region S1 and the third region S3 are substantially identical, and the areas of the second region S2 and the fourth region S4 are substantially identical. As such, the deflection angles of the liquid crystal of the respective display regions are individually different in the power-on state. As shown in FIG. 9, there are four deflection angles of the liquid crystal 7 in the LCD device. Therefore, with observations in different viewing angles, anisotropy of the liquid crystal is well averaged, which can further reduce the chromatic aberration of the LCD device.

Second Situation—each of the sub-pixel units including four sub-pixels driven by the same gate line and the same data line, each sub-pixel is set as one display region.

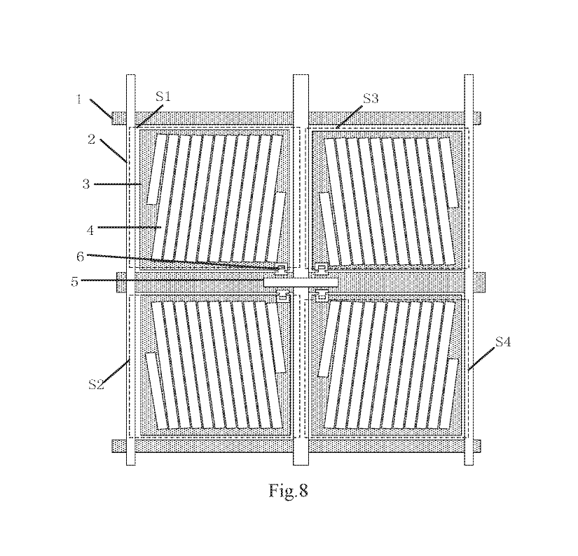

As shown in FIG. 8, in a particular example, each of the sub-pixel units includes a first sub-pixel and a second sub-pixel whose areas are substantially identical as well as a third sub-pixel and a fourth sub-pixel whose areas are substantially identical, the first sub-pixel and the second sub-pixel being arranged at the same side of the data line which drives the sub-pixel unit, the third sub-pixel and the fourth sub-pixel being arranged at the same side of the data line which drives the sub-pixel unit, the first sub-pixel and the third sub-pixel being arranged at different sides of the data line which drives the sub-pixel unit, the second sub-pixel and the fourth sub-pixel being arranged at different sides of the data line which drives the sub-pixel unit; the first sub-pixel unit and the third sub-pixel being arranged at the same side of the gate line which drives the sub-pixel unit, the second sub-pixel unit and the fourth sub-pixel being arranged at the same side of the gate line which drives the sub-pixel unit, the first sub-pixel unit and the second sub-pixel being arranged at the different sides of the gate line which drives the sub-pixel unit, the third sub-pixel unit and the fourth sub-pixel being arranged at the different sides of the gate line which drives the sub-pixel unit. The first sub-pixel corresponds to a first region S1, the second sub-pixel corresponds to a second region S2, the third sub-pixel corresponds to a third region S3, and the fourth sub-pixel corresponds to a fourth region S4. A set of strip pixel electrodes 3 with substantially the same inclination angle is arranged in each of the display regions as described above. The sub-pixel unit further includes a first TFT which drives the first sub-pixel for display, a second TFT which drives the second sub-pixel for display, a third TFT which drives the third sub-pixel for display, a fourth TFT which drives the fourth sub-pixel for display. Gate electrodes of the first TFT, the second TFT, the third TFT and the fourth TFT are connected, and source electrodes of the first TFT, the second TFT, the third TFT and the fourth TFT are connected, so as to ensure that the first TFT, the second TFT, the third TFT and the fourth TFT are driven by the same gate line and the same data line. In a substantially parallel direction along the gate line, the strip pixel electrodes of the first sub-pixel and the second sub-pixel are arranged symmetrically, and the strip pixel electrodes of the third sub-pixel and the fourth sub-pixel are arranged symmetrically, width-length ratios of channels of the first TFT and the second TFT are substantially identical, and width-length ratios of channels of the third TFT and the fourth TFT are substantially identical.

In order that in the power-on state, the electric fields generated by the respective display regions are different, and thus the deflection angles of the liquid crystal of the respective display regions are individually different for implementing the four-domain display. In particular implementations may include, but be not limited to:

First Implementation 1, in which the inclination angles of the strip pixel electrodes of the first sub-pixel and the third sub-pixel are substantially identical, and the inclination angles of the strip pixel electrodes of the second sub-pixel and the fourth sub-pixel are substantially identical, either; the width-length ratios of channels of the first TFT and the third TFT are substantially identical, and the width-length ratios of channels of the second TFT and the fourth TFT are substantially identical, either; and areas of the first sub-pixel and the third sub-pixel are different, and areas of the second sub-pixel and the fourth sub-pixel are different. As such, the deflection angles of the liquid crystal of the respective display regions are individually different in the power-on state. As shown in FIG. 9, there are four deflection angles of the liquid crystal 7 in the LCD device. Therefore, with observations in different viewing angles, anisotropy of the liquid crystal is well averaged, which can further reduce the chromatic aberration of the LCD device. In order to reduce the chromatic aberration better to obtain a better display effect, an area ratio between the first sub-pixel and the third sub-pixel may be within a range from 1:1 to 1:9, and accordingly, an area ratio between the second sub-pixel and the fourth sub-pixel may be within a range from 1:1 to 1:9.

Second Implementation 2, in which the inclination angles of the strip pixel electrodes of the first sub-pixel and the third sub-pixel are substantially identical, and the inclination angles of the strip pixel electrodes of the second sub-pixel and the fourth sub-pixel are substantially identical, either; the width-length ratios of channels of the first TFT and the third TFT are different, and the width-length ratios of channels of the second TFT and the fourth TFT are different; and the areas of the first sub-pixel and the third sub-pixel are substantially identical, and the areas of the second sub-pixel and the fourth sub-pixel are substantially identical. As such, the deflection angles of the liquid crystal of the respective display regions are individually different in the power-on state. As shown in FIG. 9, there are four deflection angles of the liquid crystal 7 in the LCD device. Therefore, with observations in different viewing angles, anisotropy of the liquid crystal is well averaged, which can further reduce the chromatic aberration of the LCD device.

Third Implementation 3, in which the inclination angles of the strip pixel electrodes of the first sub-pixel and the third sub-pixel are different, and the inclination angles of the strip pixel electrodes of the second sub-pixel and the fourth sub-pixel are different, either; the width-length ratios of channels of the first TFT and the third TFT are substantially identical, and the width-length ratios of channels of the second TFT and the fourth TFT are substantially identical; and the areas of the first sub-pixel and the third sub-pixel are substantially identical, and the areas of the second sub-pixel and the fourth sub-pixel are substantially identical. As such, the deflection angles of the liquid crystal of the respective display regions are individually different in the power-on state. As shown in FIG. 9, there are four deflection angles of the liquid crystal 7 in the LCD device. Therefore, with observations in different viewing angles, anisotropy of the liquid crystal is well averaged, which can further reduce the chromatic aberration of the LCD device.

In another particular example, each of the sub-pixel units includes a first sub-pixel and a second sub-pixel whose areas are substantially identical as well as a third sub-pixel and a fourth sub-pixel whose areas are substantially identical, the first sub-pixel and the second sub-pixel being arranged at the same side of the gate line which drives the sub-pixel unit, the third sub-pixel and the fourth sub-pixel being arranged at the same side of the gate line which drives the sub-pixel unit, the first sub-pixel and the third sub-pixel being arranged at different sides of the gate line which drives the sub-pixel unit, the second sub-pixel and the fourth sub-pixel being arranged at different sides of the gate line which drives the sub-pixel unit; the first sub-pixel unit and the third sub-pixel being arranged at the same side of the data line which drives the sub-pixel unit, the second sub-pixel unit and the fourth sub-pixel being arranged at the same side of the data line which drives the sub-pixel unit, the first sub-pixel unit and the second sub-pixel being arranged at the different sides of the data line which drives the sub-pixel unit, the third sub-pixel unit and the fourth sub-pixel being arranged at the different sides of the data line which drives the sub-pixel unit. The first sub-pixel corresponds to a first region S1, the second sub-pixel corresponds to a second region S2, the third sub-pixel corresponds to a third region S3, and the fourth sub-pixel corresponds to a fourth region S4. A set of strip pixel electrodes 3 with substantially the same inclination angle is arranged in each of the display regions as described above. The sub-pixel unit further comprises a first TFT which drives the first sub-pixel for display, a second TFT which drives the second sub-pixel for display, a third TFT which drives the third sub-pixel for display, a fourth TFT which drives the fourth sub-pixel for display. Gate electrodes of the first TFT, the second TFT, the third TFT and the fourth TFT are connected, and source electrodes of the first TFT, the second TFT, the third TFT and the fourth TFT are connected, so as to ensure that the first TFT, the second TFT, the third TFT and the fourth TFT are driven by the same gate line and the same data line. In a substantially parallel direction along the data line, the strip pixel electrodes of the first sub-pixel and the second sub-pixel are arranged symmetrically, and the strip pixel electrodes of the third sub-pixel and the fourth sub-pixel are arranged symmetrically, width-length ratios of channels of the first TFT and the second TFT are substantially identical, and width-length ratios of channels of the third TFT and the fourth TFT are substantially identical.

In order that in the power-on state, the electric fields generated by the respective display regions are different, and thus the deflection angles of the liquid crystal of the respective display regions are individually different for implementing the four-domain display. In particular implementations may include, but be not limited to:

First Implementation 1, in which the inclination angles of the strip pixel electrodes of the first sub-pixel and the third sub-pixel are substantially identical, and the inclination angles of the strip pixel electrodes of the second sub-pixel and the fourth sub-pixel are substantially identical, either; the width-length ratios of channels of the first TFT and the third TFT are substantially identical, and the width-length ratios of channels of the second TFT and the fourth TFT are substantially identical, either; and areas of the first sub-pixel and the third sub-pixel are different, and areas of the second sub-pixel and the fourth sub-pixel are different. As such, the deflection angles of the liquid crystal of the respective display regions are individually different in the power-on state. As shown in FIG. 9, there are four deflection angles of the liquid crystal 7 in the LCD device. Therefore, with observations in different viewing angles, anisotropy of the liquid crystal is well averaged, which can further reduce the chromatic aberration of the LCD device. In order to reduce the chromatic aberration better to obtain a better display effect, an area ratio between the first sub-pixel and the third sub-pixel may be within a range from 1:1 to 1:9, and accordingly, an area ratio between the second sub-pixel and the fourth sub-pixel may be within a range from 1:1 to 1:9.

Second Implementation 2, in which the inclination angles of the strip pixel electrodes of the first sub-pixel and the third sub-pixel are substantially identical, and the inclination angles of the strip pixel electrodes of the second sub-pixel and the fourth sub-pixel are substantially identical, either; the width-length ratios of channels of the first TFT and the third TFT are different, and the width-length ratios of channels of the second TFT and the fourth TFT are different; and the areas of the first sub-pixel and the third sub-pixel are substantially identical, and the areas of the second sub-pixel and the fourth sub-pixel are substantially identical. As such, the deflection angles of the liquid crystal of the respective display regions are individually different in the power-on state. As shown in FIG. 9, there are four deflection angles of the liquid crystal 7 in the LCD device. Therefore, with observations in different viewing angles, anisotropy of the liquid crystal is well averaged, which can further reduce the chromatic aberration of the LCD device.

Third Implementation 3, in which the inclination angles of the strip pixel electrodes of the first sub-pixel and the third sub-pixel are different, and the inclination angles of the strip pixel electrodes of the second sub-pixel and the fourth sub-pixel are different, either; the width-length ratios of channels of the first TFT and the third TFT are substantially identical, and the width-length ratios of channels of the second TFT and the fourth TFT are substantially identical; and the areas of the first sub-pixel and the third sub-pixel are substantially identical, and the areas of the second sub-pixel and the fourth sub-pixel are substantially identical. As such, the deflection angles of the liquid crystal of the respective display regions are individually different in the power-on state. As shown in FIG. 9, there are four deflection angles of the liquid crystal 7 in the LCD device. Therefore, with observations in different viewing angles, anisotropy of the liquid crystal is well averaged, which can further reduce the chromatic aberration of the LCD device.

Further, in the above embodiments, in the LCD panel in which a number of pixel structures are applied, when the liquid crystal of the display region in which the strip pixel electrodes are located is positive liquid crystal, a range of an angle between an inclination orienting direction of the strip pixel electrodes and an initial direction of the positive liquid crystal is 5°˜20°. Or, when the liquid crystal of the display region in which the strip pixel electrodes are located is negative liquid crystal, a range of an angle between an inclination orienting direction of the strip pixel electrodes and an initial orienting direction of the negative liquid crystal is 70°˜85°. When the strip pixel electrodes have the inclination angle as described above, a response velocity of the liquid crystal may be increased, the chromatic aberration of the LCD device may be reduced, and a picture quality of the LCD device may be improved.

### Second Embodiment

An embodiment of the present disclosure further provides an array substrate on which a plurality of pixel structures as described above is formed. In the array substrate with the above pixel structures, the sub-pixel unit driven by the same gate line and the same data line is divided into the plurality of display regions; and in the power-on state, the electric fields generated by respective display regions are different. As such, when the array substrate works, the deflection angles of the liquid crystal of the respective display regions are different, which can implement the multi-domain display, so that the difference in brightness of the LCD device is further reduced, and thus the chromatic aberration phenomenon is effectively improved. In addition, since each sub-pixel unit comprises two or more sub-pixels, it is not necessary to form strip pixel electrodes having a plurality of inclination angles in each sub-pixel, which can reduce adverse effect on the transmittance of the LCD device.

### Third Embodiment

An embodiment of the present disclosure further provides a display device comprising the array substrate as described above. The display device may be any product or component with a display function, such as a liquid crystal panel, a liquid crystal TV, a liquid crystal display, a digital photo frame, a mobile phone, a tablet, and so forth.

The above are merely the preferred embodiments of the present invention. It should be appreciated that, a person skilled in the art may make further improvements and modifications without departing from the principle of the present invention, and these improvements and modifications shall also be considered as the scope of the present invention.

What is claimed is:

1. A pixel structure, comprising:
a plurality of sub-pixel units driven by a same gate line and a same data line,
wherein each of the sub-pixel units consists of two or more sub-pixels, and is divided into N display regions; and wherein in a power-on state, an N-domain display is implemented by the sub-pixel unit due to different electric fields generated by different display regions respectively.

2. The pixel structure according to claim 1, wherein each of the sub-pixel units is divided into four display regions.

3. The pixel structure according to claim 2, wherein each of the sub-pixel units comprises two sub-pixels driven by the same gate line and the same data line, each sub-pixel being divided into two display regions.

4. The pixel structure according to claim 3, wherein each of the sub-pixel units consists of a first sub-pixel and a second sub-pixel distributed in a substantially parallel direction along the gate line, the sub-pixel unit comprising a first thin film transistor (TFT) which drives the first sub-pixel for display and a second TFT which drives the second sub-pixel for display, a gate electrode of the first TFT being connected to a gate electrode of the second TFT, a source electrode of the first TFT being connected to a source electrode of the second TFT; in a substantially parallel direction along the data line, the first sub-pixel is divided into a first region and a second region whose areas are substantially identical, and the second sub-pixel is divided into a third region and a fourth region whose areas are substantially identical; and strip pixel electrodes of the first region and the second region are arranged symmetrically, and strip pixel electrodes of the third region and the fourth region are arranged symmetrically;
wherein
inclination angles of the strip pixel electrodes of the first region and the third region are substantially identical, width-length ratios of channels of the first TFT and the second TFT are substantially identical, and areas of the first region and the third region are different; or
inclination angles of the strip pixel electrodes of the first region and the third region are substantially identical, width-length ratios of channels of the first TFT and the second TFT are different, and areas of the first region and the third region are substantially identical; or
inclination angles of the strip pixel electrodes of the first region and the third region are different, width-length ratios of channels of the first TFT and the second TFT are substantially identical, and areas of the first region and the third region are substantially identical.

5. The pixel structure according to claim 3, wherein each of the sub-pixel units consists of a first sub-pixel and a second sub-pixel distributed in a substantially parallel direction along the data line, the sub-pixel unit comprising a first thin film transistor (TFT) which drives the first sub-pixel for display and a second TFT which drives the second sub-pixel for display, a gate electrode of the first TFT being connected to a gale electrode of the second TFT, a source electrode of the first TFT being connected to a source electrode of the second TFT; in a substantially parallel direction along the gate line, the first sub-pixel is divided into a first region and a second region whose areas are substantially identical, and the second sub-pixel is divided into a third region and a fourth region whose areas are substantially identical; and strip pixel electrodes of the first region and the second region are arranged symmetrically, and strip pixel electrodes of the third region and the fourth region are arranged symmetrically;
wherein
inclination angles of the strip pixel electrodes of the first region and the third region are substantially identical, width-length ratios of channels of the first TFT and the second TFT are substantially identical, and areas of the first region and the third region are different; or
inclination angles of the strip pixel electrodes of the first region and the third region are substantially identical, width-length ratios of channels of the first TFT and the second TFT are different, and areas of the first region and the third region are substantially identical; or
inclination angles of the strip pixel electrodes of the first region and the third region are different, width-length ratios of channels of the first TFT and the second TFT are substantially identical, and areas of the first region and the third region are substantially identical.

6. The pixel structure according to claim 2, wherein each of the sub-pixel units comprises four sub-pixels driven by the same gate line and the same data line, each sub-pixel being as one display region.

7. The pixel structure according to claim 6, wherein each of the sub-pixel units comprises a first sub-pixel and a second sub-pixel whose areas are substantially identical as well as a third sub-pixel and a fourth sub-pixel whose areas are substantially identical, and further comprises a first TFT which drives the first sub-pixel for display, a second TFT which drives the second sub-pixel for display, a third TFT which drives the third sub-pixel for display, a fourth TFT which drives the fourth sub-pixel for display, gate electrodes of the first TFT, the second TFT, the third TFT and the fourth TFT being connected, source electrodes of the first TFT, the second TFT, the third TFT and the fourth TFT being connected; in a substantially parallel direction along the gate line, strip pixel electrodes of the first sub-pixel and the second sub-pixel are arranged symmetrically, strip pixel electrodes of the third sub-pixel and the fourth sub-pixel are arranged symmetrically, width-length ratios of channels of the first TFT and the second TFT are substantially identical, and width-length ratios of channels of the third TFT and the fourth TFT are substantially identical;
wherein
inclination angles of the strip pixel electrodes of the first sub-pixel and the third sub-pixel are substantially identical, width-length ratios of channels of the first TFT and the third TFT are substantially identical, and areas of the first sub-pixel and the third sub-pixel are different; or
inclination angles of the strip pixel electrodes of the first sub-pixel and the third sub-pixel are substantially identical, width-length ratios of channels of the first TFT and the third TFT are different, and areas of the first sub-pixel and the third sub-pixel are substantially identical; or
inclination angles of the strip pixel electrodes of the first sub-pixel and the third sub-pixel are different, width-length ratios of channels of the first TFT and the third TFT are substantially identical, and areas of the first sub-pixel and the third sub-pixel are substantially identical.

8. The pixel structure according to claim 6, wherein each of the sub-pixel units comprises a first sub-pixel and a second sub-pixel whose areas are substantially identical as well as a third sub-pixel and a fourth sub-pixel whose areas are substantially identical, and further comprises a first TFT which drives the first sub-pixel for display, a second TFT which drives the second sub-pixel for display, a third TFT which drives the third sub-pixel for display, a fourth TFT which drives the fourth sub-pixel for display, gate electrodes of the first ‘TF’T, the second TFT, the third TFT and the fourth TFT being connected, source electrodes of the first TFT, the second TFT, the third TFT and the fourth TFT being connected; in a substantially parallel direction along the data line, strip pixel electrodes of the first sub-pixel and the second sub-pixel are arranged symmetrically, strip pixel electrodes of the third sub-pixel and the fourth sub-pixel are arranged symmetrically, width-length ratios of channels of the first TFT and the second TFT are substantially identical, and width-length ratios of channels of the third TFT and the fourth TFT are substantially identical;
wherein
inclination angles of the strip pixel electrodes of the first sub-pixel and the third sub-pixel are substantially identical, width-length ratios of channels of the first TFT and the third TFT are substantially identical, and areas of the first sub-pixel and the third sub-pixel are different; or
inclination angles of the strip pixel electrodes of the first sub-pixel and the third sub-pixel are substantially identical, width-length ratios of channels of the first TFT and the third TFT are different, and areas of the first sub-pixel and the third sub-pixel are substantially identical; or
inclination angles of the strip pixel electrodes of the first sub-pixel and the third sub-pixel are different, width-length ratios of channels of the first TFT and the third TFT are substantially identical, and areas of the first sub-pixel and the third sub-pixel are substantially identical.

9. The pixel structure according to claim 4, wherein in a liquid crystal display (LCD) panel in which a number of pixel structures are applied,
when liquid crystal of the display region in which the strip pixel electrodes are located is positive liquid crystal, a range of an angle between an inclination orienting direction of the strip pixel electrodes and an initial orienting direction of the positive liquid crystal is 5°˜20°; or
when liquid crystal of the display region in which the strip pixel electrodes are located is negative liquid crystal, a range of an angle between an inclination orienting direction of the strip pixel electrodes and an initial orienting direction of the negative liquid crystal is 70°˜85°.

10. The pixel structure according to claim 4, wherein
an area ratio between the first region and the third region is within a range from 1:1 to 1:9, and an area ratio between the second region and the fourth region is within a range from 1:1 to 1:9.

11. An array substrate including a plurality of pixel structures, wherein each of the pixel structures comprises:
a plurality of sub-pixel units driven by a same gate line and a same data line,
wherein each of the sub-pixel units consists of two or more sub-pixels, and is divided into N display regions; and wherein in a power-on state, an N-domain display is implemented by the sub-pixel unit due to different electric fields generated by different display regions respectively.

12. The array substrate according to claim 11, wherein each of the sub-pixel units is divided into four display regions.

13. The array substrate according to claim 12, wherein each of the sub-pixel units comprises two sub-pixels driven by the same gate line and the same data line, each sub-pixel being divided into two display regions.

14. The array substrate according to claim 13, wherein each of the sub-pixel units consists of a first sub-pixel and a second sub-pixel distributed in a substantially parallel direction along the gate line, the sub-pixel unit comprising a first thin film transistor (TFT) which drives the first sub-pixel for display and a second TFT which drives the second sub-pixel for display, a gate electrode of the first TFT being connected to a gate electrode of the second TFT, a source electrode of the first TFT being connected to a source electrode of the second TFT; in a substantially parallel direction along the data line, the first sub-pixel is divided into a first region and a second region whose areas are substantially identical, and the second sub-pixel is divided into a third region and a fourth region whose areas are substantially identical; and strip pixel electrodes of the first region and the second region are arranged symmetrically, and strip pixel electrodes of the third region and the fourth region are arranged symmetrically;
wherein
inclination angles of the strip pixel electrodes of the first region and the third region are substantially identical, width-length ratios of channels of the first TFT and the second TFT are substantially identical, and areas of the first region and the third region are different; or
inclination angles of the strip pixel electrodes of the first region and the third region are substantially identical, width-length ratios of channels of the first TFT and the second TFT are different, and areas of the first region and the third region are substantially identical; or
inclination angles of the strip pixel electrodes of the first region and the third region are different, width-length ratios of channels of the first TFT and the second TFT are substantially identical, and areas of the first region and the third region are substantially identical.

15. The array substrate according to claim 13, wherein each of the sub-pixel units consists of a first sub-pixel and a second sub-pixel distributed in a substantially parallel direction along the data line, the sub-pixel unit comprising a first thin film transistor (TFT) which drives the first sub-pixel for display and a second TFT which drives the second sub-pixel for display, a gate electrode of the first TFT being connected to a gate electrode of the second TFT, a source electrode of the first TFT being connected to a source electrode of the second TFT; in a substantially parallel direction along the gate line, the first sub-pixel is divided into a first region and a second region whose areas are substantially identical, and the second sub-pixel is divided into a third region and a fourth region whose areas are substantially identical; and strip pixel electrodes of the first region and the second region are arranged symmetrically, and strip pixel electrodes of the third region and the fourth region are arranged symmetrically;
wherein
inclination angles of the strip pixel electrodes of the first region and the third region are substantially identical, width-length ratios of channels of the first TFT and the second TFT are substantially identical, and areas of the first region and the third region are different; or
inclination angles of the strip pixel electrodes of the first region and the third region are substantially identical, width-length ratios of channels of the first TFT and the second TFT are different, and areas of the first region and the third region are substantially identical; or
inclination angles of the strip pixel electrodes of the first region and the third region are different, width-length ratios of channels of the first TFT and the second TFT are substantially identical, and areas of the first region and the third region are substantially identical.

16. The array substrate according to claim 12, wherein each of the sub-pixel units comprises four sub-pixels driven by the same gate line and the same data line, each sub-pixel being as one display region.

17. The array substrate according to claim 16, wherein each of the sub-pixel units comprises a first sub-pixel and a second sub-pixel whose areas are substantially identical as well as a third sub-pixel and a fourth sub-pixel whose areas are substantially identical, and further comprises a first TFT which drives the first sub-pixel for display, a second TFT which drives the second sub-pixel for display, a third TFT which drives the third sub-pixel for display, a fourth TFT which drives the fourth sub-pixel for display, gate electrodes of the first TFT, the second TFT, the third TFT and the fourth TFT being connected, source electrodes of the first TFT, the second TFT, the third TFT and the fourth TFT being connected; in a substantially parallel direction along the gate line, strip pixel electrodes of the first sub-pixel and the second sub-pixel are arranged symmetrically, strip pixel electrodes of the third sub-pixel and the fourth sub-pixel are arranged symmetrically, width-length ratios of channels of the first TFT and the second TFT are substantially identical, and width-length ratios of channels of the third TFT and the fourth TFT are substantially identical;
wherein
inclination angles of the strip pixel electrodes of the first sub-pixel and the third sub-pixel are substantially identical, width-length ratios of channels of the first TFT and the third TFT are substantially identical, and areas of the first sub-pixel and the third sub-pixel are different; or
inclination angles of the strip pixel electrodes of the first sub-pixel and the third sub-pixel are substantially identical, width-length ratios of channels of the first TFT and the third TFT are different, and areas of the first sub-pixel and the third sub-pixel are substantially identical; or
inclination angles of the strip pixel electrodes of the first sub-pixel and the third sub-pixel are different, width-length ratios of channels of the first TFT and the third TFT are substantially identical, and areas of the first sub-pixel and the third sub-pixel are substantially identical.

18. The array substrate according to claim 16, wherein each of the sub-pixel units comprises a first sub-pixel and a second sub-pixel whose areas are substantially identical as well as a third sub-pixel and a fourth sub-pixel whose areas are substantially identical, and further comprises a first TFT which drives the first sub-pixel for display, a second TFT which drives the second sub-pixel for display, a third TFT which drives the third sub-pixel for display, a fourth TFT which drives the fourth sub-pixel for display, gate electrodes of the first TFT, the second TFT, the third TFT and the fourth TFT being connected, source electrodes of the first TFT, the second TFT, the third TFT and the fourth TFT being connected; in a substantially parallel direction along the data line, strip pixel electrodes of the first sub-pixel and the second sub-pixel are arranged symmetrically, strip pixel electrodes of the third sub-pixel and the fourth sub-pixel are arranged symmetrically, width-length ratios of channels of the first TFT and the second TFT are substantially identical, and width-length ratios of channels of the third TFT and the fourth TFT are substantially identical;
wherein
inclination angles of the strip pixel electrodes of the first sub-pixel and the third sub-pixel are substantially identical, width-length ratios of channels of the first TFT and the third TFT are substantially identical, and areas of the first sub-pixel and the third sub-pixel are different; or
inclination angles of the strip pixel electrodes of the first sub-pixel and the third sub-pixel are substantially identical, width-length ratios of channels of the first TFT and the third TFT are different, and areas of the first sub-pixel and the third sub-pixel are substantially identical; or
inclination angles of the strip pixel electrodes of the first sub-pixel and the third sub-pixel are different, width-length ratios of channels of the first TFT and the third TFT are substantially identical, and areas of the first sub-pixel and the third sub-pixel are substantially identical.

19. The array substrate according to claim 14, wherein in a liquid crystal display (LCD) panel in which a number of pixel structures are applied,
when liquid crystal of the display region in which the strip pixel electrodes are located is positive liquid crystal, a range of an angle between an inclination orienting direction of the strip pixel electrodes and an initial direction of the positive liquid crystal is 5°˜20°; or
when liquid crystal of the display region in which the strip pixel electrodes are located is negative liquid crystal, a range of an angle between an inclination orienting direction of the strip pixel electrodes and an initial orienting direction of the negative liquid crystal is 70°˜85°.

20. A display device, comprising an array substrate, the array substrate including a plurality of pixel structures, wherein each of the pixel structures comprises:
a plurality of sub-pixel units driven by a same gate line and a same data line,
wherein each of the sub-pixel units consists of two or more sub-pixels, and is divided into N display regions; and wherein in a power-on state, an N-domain display is implemented by the sub-pixel unit due to different electric fields generated by different display regions respectively.
